(19) United States
(12) Patent Application Publication
(10) Pub. No.: US 2005/0274050 A1
(43) Pub. Date: Dec. 15, 2005

(54) Moving condition display apparatus for a vehicle

(76) Inventor: An-Sheng Liu, Taichung City (TW)

Correspondence Address: AN SHENG LIU, P.O. Box 63-150, Taichung City, 406, TW

(21) Appl. No.: 10/909,856

(22) Filed: Aug. 3, 2004

(30) Foreign Application Priority Data
Jun. 14, 2004 (TW) 093209378

(51) Int. Cl. G09F 21/04

(52) U.S. Cl. 40/544; 40/593

(57) ABSTRACT

A moving condition display apparatus for a vehicle includes a casing, a display panel and a project panel sequentially mounted into the casing. The display panel includes a first series, a second series and a third series of LEDs respectively arranged to a speed up display area, a cruise display area and a brake display area. The first series of LEDs lights when the accelerator of the vehicle is operated to speed up the vehicle. The second series of LEDs light when the accelerator is released and the speed of the vehicle is gradually slowed down. The third series of LEDs lights when the brake system of the vehicle is actuated to rapidly slow down the vehicle.

### BACKGROUND OF THE INVENTION

1. Field of the Invention

The present invention relates to a moving condition display apparatus for a vehicle, and more particularly to a moving condition display apparatus for a vehicle that shows an instantaneous moving condition of the vehicle for other moving vehicles to promote the safety of driving.

2. Description of Related Art

Many traffic accidents are occurred when braking or turning due to the following driver cannot effectively master moving condition of others vehicles. However, the current vehicles only have a brake lamp and multiple turn signals. The brake lamp only lights when the brake system of the vehicle is actuated. However, there is no element to warn the following driver when the speed of the front vehicle is gradually slowed down. At the moment, the following vehicle may crash the front vehicle when the front vehicle is emergently braked or turned.

The present invention has arisen to mitigate and/or obviate the disadvantages of the current vehicles having no enough display apparatus for warning the following driver.

### SUMMARY OF THE INVENTION

The main objective of the present invention is to provide an improved moving condition display apparatus for a vehicle, which can provide a clear warning to others vehicles.

To achieve the objective, the moving condition display apparatus in accordance with the present invention comprises at least one casing secured on the vehicle and correspond to a moving direction of the vehicle. A display panel is facially mounted into the casing and includes a first series of light emitting diodes (LEDs), a second series of LEDs and a third series of LEDs electrically mounted on a front side of the display panel. The first series of LEDs are arranged for a speed up display area, the second series of LEDs are arranged for a cruise display area without overlapping the first series of LEDs and the third series of LEDs are arranged for a brake display area with overlapping the first series of LEDs and the second series of LEDs. The first series of LEDs and the second series of LEDs are electrically connected to a accelerator of the vehicle and the third series of LEDs are electrically connected to a brake system of the vehicle. A transparent project panel is facially mounted into the casing and received in the opening. The transparent project panel overlaps and is parallel to the display panel such that the light rays from the display panel can favorably go through the transparent project panel.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a moving condition display apparatus for a vehicle in accordance with the present invention;

FIG. 2 is a front view of the moving condition display apparatus for a vehicle in accordance with the present invention;

FIG. 3 is an operational front of the moving condition display apparatus of the present invention when speeding up;

FIG. 4 is an operational front of the moving condition display apparatus of the present invention when speeding down;

FIG. 5 is an operational front of the moving condition display apparatus of the present invention when braking;

FIG. 6 is a front view of a second embodiment of the moving condition display apparatus for a vehicle in accordance with the present invention;

FIG. 7 is an operational front of the moving condition display apparatus in FIG. 6 when speeding up;

FIG. 8 is an operational front of the moving condition display apparatus in FIG. 6 when speeding down;

FIG. 9 is an operational front of the moving condition display apparatus in FIG. 6 when braking;

FIG. 10 is a schematic view of the moving condition display of the present invention when being mounted on an automobile;

FIG. 11 is a second schematic view of the moving condition display of the present invention when being mounted on a motorcycle; and

FIG. 12 is a circuit diagram of the moving condition display apparatus for a vehicle in accordance with the present invention.

### DETAILED DESCRIPTION OF THE INVENTION

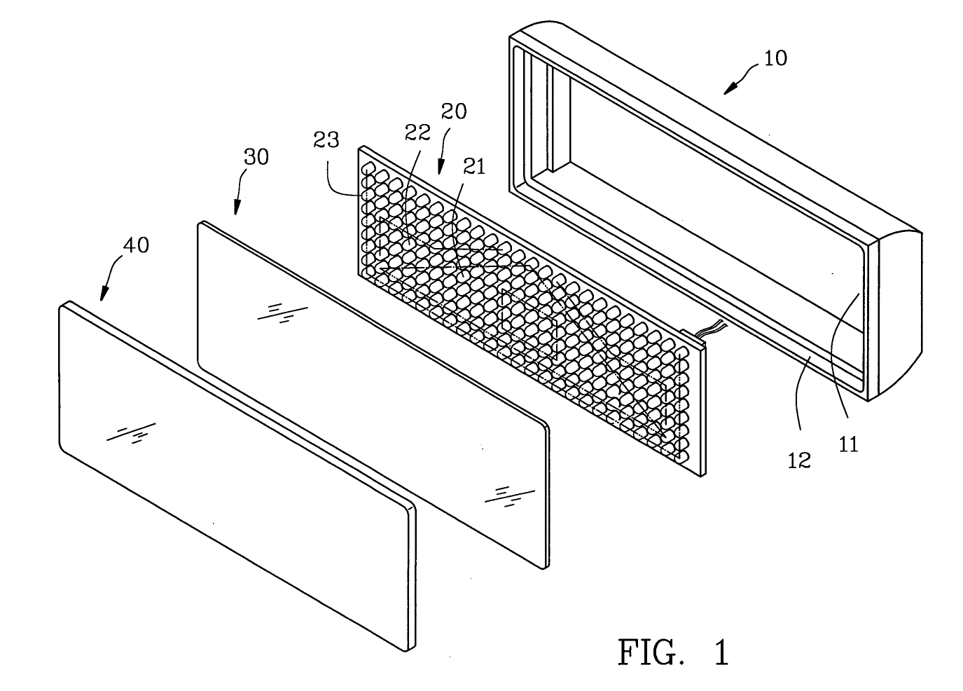

Referring to the drawings and initially to FIGS. 1 and 10-11, a moving condition display apparatus for a vehicle in accordance with the present invention is divided into two portions respectively mounted on a front and a rear end along the moving direction of the vehicle and each comprises casing (10), a display panel (20) and a project panel (30) sequentially attached to the casing (10).

The casing (10) is mounted on an automobile (1) or a scooter (2) and aligns with a moving direction of the automobile (1) or the scooter (2). The casing (10) includes an axis (S) linearly corresponding to that of a body of the automobile (1)/scooter (2). A chamber (11) is defined in the casing (10) and extends to an outer periphery of the casing (10) to form an opening (12).

The display panel (20) is facially mounted into the casing (10) and received in the opening (11). The display panel (20) includes a first series of light emitting diode (LED 21), a second series of LEDs (22) and a third series of LEDs (23) electrically mounted on a front side of the display panel (20). In the preferred embodiment of the present invention, the first series of LEDs (21) lights green ray, the second series of LEDs (22) light yellow ray and the third series of LEDs (23) lights red ray.

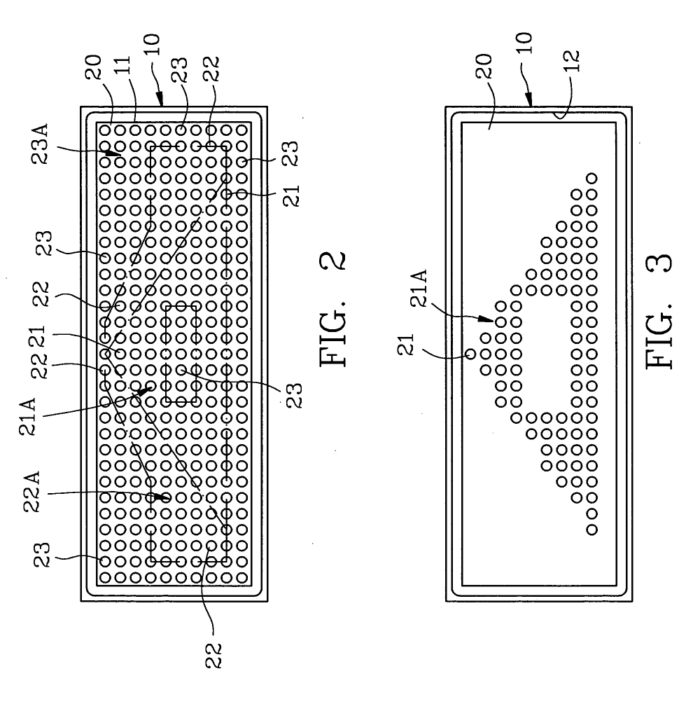

With reference to FIG. 2, the first series of LEDs (21) are arranged for a speed up display area (21A). The second series of LEDs (22) are arranged for a cruise display area (22A) without overlapping the first series of LEDs (21). The third series of LEDs (23) are arranged for a brake display area (23A) without overlapping the first series of LEDs (21) and the second series of LEDs (22).

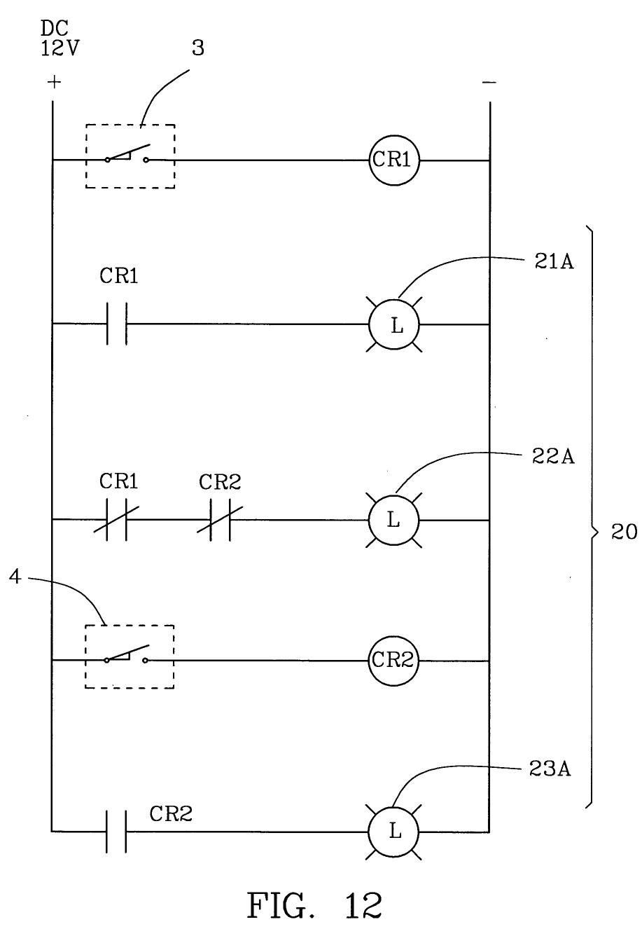

Further with reference to FIG. 12, the first series of LEDs (21) of the speed up display area (21A) and the second series of LEDs (22) of the cruise display area (22A) are electrically connected to an accelerator (3) of the vehicle, and the third series of LEDs (23) of the brake display area (23A) are electrically connected to a brake system (4) of the vehicle.

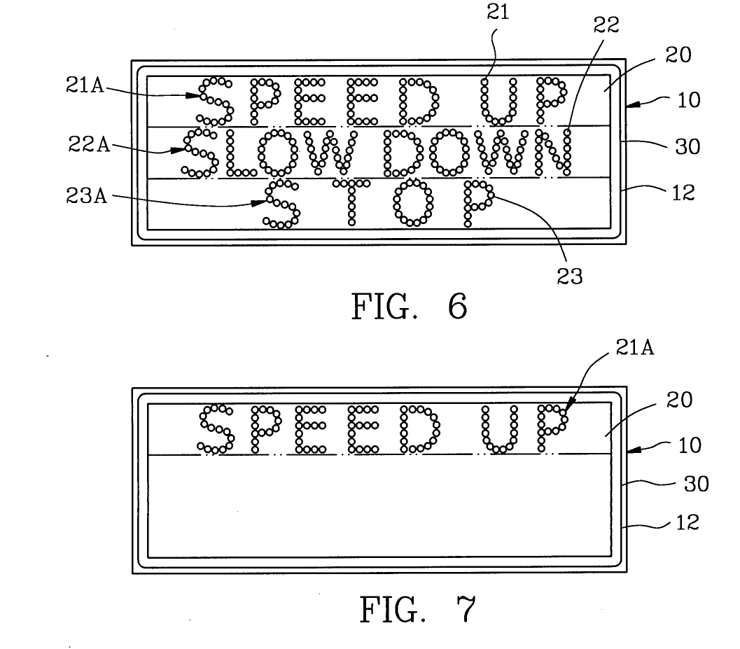

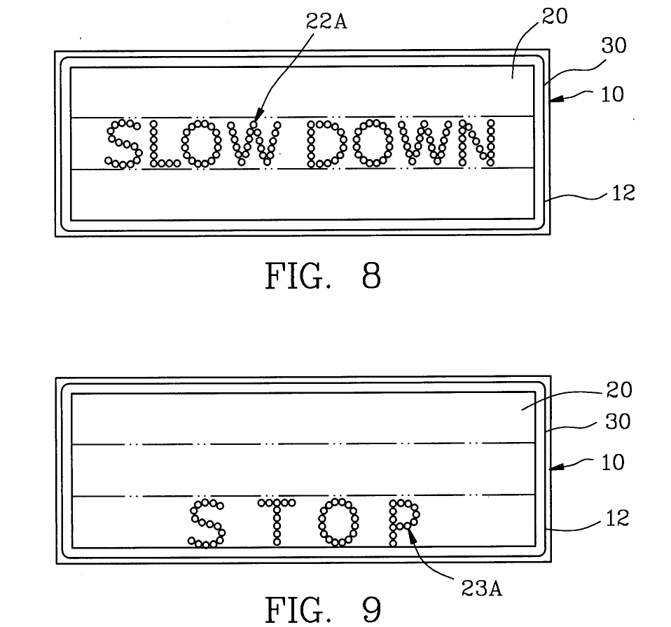

With reference to FIG. 6, the first series of LEDs (21) of the speed up display area (21A), the second series of LEDs (22) of the cruise display area (22A) and the third series of LEDs (23) of the brake display area (23A) are respectively patterned, such as characters for clearly showing the moving condition of a vehicle.

The project panel (30) is facially mounted into the casing (10) and received in the opening (11). The project panel (30) is transparent and parallel relative to the display panel (20) such that the light ray from the display panel (20) favorably goes through the project panel (30).

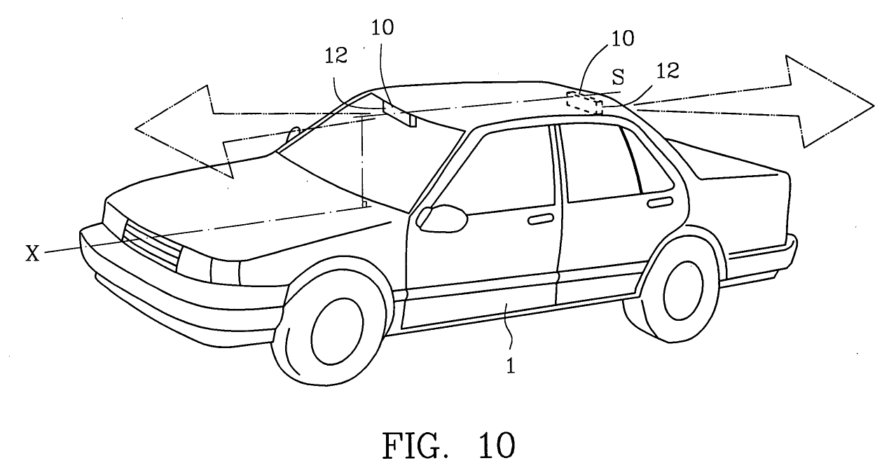

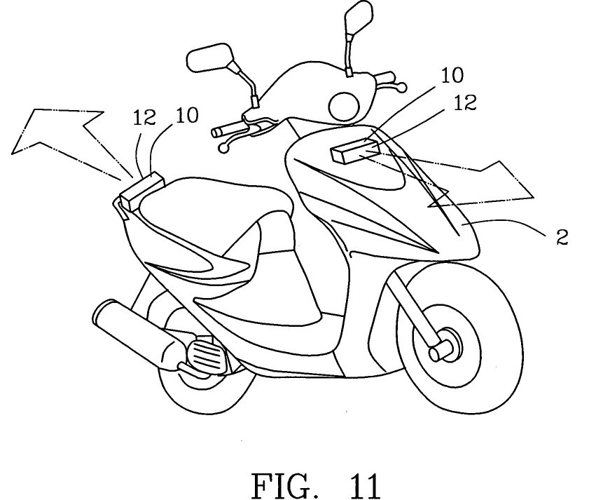

With reference to FIG. 10, the moving condition display apparatus of the present invention is secured on a front windshield and a rear windshield of the automobile and with reference to FIG. 11, the moving condition display apparatus of the present invention is mounted to a front portion and a rear portion of the motorcycle for other vehicles to mutually master the moving condition thereof.

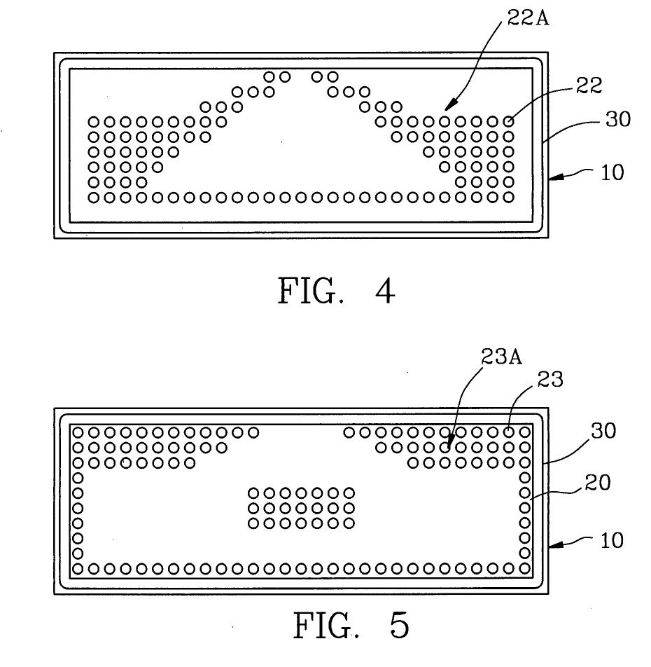

With reference to FIGS. 2-5 and 12, the circuit board of the present invention automatically obstructs the electric connections of the second series of LEDs (22) of the cruise display area (22A) and the third series of LEDs (23) of the brake display area (23A) when the accelerator (3) is operated to speed up the vehicle. Consequently, only the first series of LEDs (21) of the speed up display area (21A) are lighted for showing the vehicle is speeded up.

The circuit board of the present invention automatically obstructs the electric connections of the first series of LEDs (21) of the speed up display area (21A) and the third series of LEDs (23) of the brake display area (23A) when the accelerator (3) is released. Consequently, only the second series of LEDs (22) of the cruise display area (22A) is lighted for showing the vehicle is in a condition of cruise and the vehicle is gradually slowed down.

The circuit board of the present invention automatically obstructs the electric connections of the first series of LEDs (21) of the speed up display area (21A) and the second series of LEDs (22) of the cruise display area (22A) when the brake system of the vehicle is operated. Consequently, only the third series of LEDs (23) of the brake display area (23A) is lighted for showing the vehicle is in a condition of braking and warning others vehicle.

With reference to FIG. 6, the first series of LEDs (21) of the speed up display area (21A) are arranged in order to form characters of “SPEED UP”. The second series of LEDs (22) of the cruise display area (22A) are arranged in order to form characters of “SLOW DOWN”. The third series of LEDs (23) of the brake display area (23A) are arranged in order to form character of “STOP”. Consequently, the speed up display (21A) independently shows the characters of “SPEED UP” for warning others vehicle when the accelerator (3) the vehicle is operated to speed up. The cruise display area (22A) independently shows the characters of “SLOW DOWN” when the accelerator (3) of the vehicle is released and the speed of the vehicle is gradually slowed down. The brake display area (23A) independently shows the character of “STOP” for warning others vehicle to prevent the vehicle from a crash due to a following vehicle when the brake system of the vehicle is operated to rapidly slow down the vehicle.

With reference to FIG. 1, the moving condition display apparatus for a vehicle in accordance with the present invention further comprises a dispersal panel (40) mounted to the casing (10) and corresponding to a front side of the project panel (30). The dispersal panel (40) is parallel to the project panel (30) such that the light rays from the LEDs of the present invention are dispersed in the dispersal panel (40).

In another word, the characters of the speed up display area (21A), the cruise display area (22A) and the brake display area (23A) can no be shown via the dispersal panel (40). The light rays from the LEDs of the speed up display area (21A), the cruise display area (22A) and the brake display area (23A) are equally dispersed in the dispersal panel (40). Consequently, the dispersal panel (40) shows green light when the accelerator (3) of the vehicle is operated to speed up, shows yellow light when the accelerator (3) of the vehicle is released and shows red light when the brake system of the vehicle is operated to rapidly slow down the vehicle.

In addition, the second series of LEDs (22) of the cruise display area (22A) is continually lighted when the engine of the vehicle is started and the vehicle is in a static condition because the second series of LEDs (22) are designed to independently electrically connect to the power source of the vehicle. The second series of LEDs (22) are gone out only when the engine of the vehicle is stopped and the key detached from the lock of the vehicle. Consequently, the cruise display area (22A) provides an indication of a temporary stop when the second series of LEDs (22) are continually lighted.

Although the invention has been explained in relation to its preferred embodiment, it is to be understood that many other possible modifications and variations can be made without departing from the spirit and scope of the invention as hereinafter claimed.

1. A moving condition display apparatus for a vehicle, comprising:
at least one casing adapted to be secured on the vehicle and correspond to a moving direction of the vehicle, the at least one casing having a chamber defined therein and extending toward the moving direction of the vehicle to define an opening on an outer periphery of the at least one casing;
a display panel facially mounted into the casing and received in the opening, the display panel including a first series of light emitting diodes (LEDs), a second series of LEDs and a third series of LEDs electrically mounted on a front side of the display panel, the first series of LEDs arranged for a speed up display area, the second series of LEDs arranged for a cruise display area without overlapping the first series of LEDs and the third series of LEDs arranged for a brake display area with overlapping the first series of LEDs and the second series of LEDs, the first series of LEDs and the second series of LEDs adapted to be electrically connected to a accelerator of the vehicle and the third series of LEDs adapted to be electrically connected to a brake system of the vehicle; and
a transparent project panel facially mounted into the casing and received in the opening, the transparent project panel overlapping and parallel to the display panel such that the light rays from the display panel can favorably go through the transparent project panel;
whereby the first series of LEDs of the speed up display area lights when the accelerator of the vehicle is operated to speed up the vehicle, the second series of LEDs of the cruise display area lights when the accelerator is released and the speed of the vehicle is gradually slowed down, and the third series of LEDs of the brake display area lights when the brake system of the vehicle is actuated to rapidly slow down the vehicle.

2. The moving condition display apparatus as claimed in claim 1, wherein the first series of LEDs of the speed up display area, the second series of LEDs of the cruise display area and the third series of LEDs of the brake display area are respectively patterned for clearly showing the moving condition of the vehicle.

3. The moving condition display apparatus as claimed in claim 1, wherein the first series of LEDs light green rays, the second series of LEDs light yellow rays and the third series of LEDs light red rays.

4. The moving condition display apparatus as claimed in claim 2, wherein the first series of LEDs light green rays, the second series of LEDs light yellow rays and the third series of LEDs light red rays.

5. The moving condition display apparatus as claimed in claim 2, wherein the first series of LEDs are arranged into characters of “SPEED UP”, the second series of LEDs are arranged into characters of “SLOW DOWN” and the third series of LEDs are arranged into character of “BRAKE”.

6. The moving condition display apparatus as claimed in claim 3 further comprising a dispersal panel mounted to the casing and corresponding to a front side of the project panel, the dispersal panel parallel to the project panel such that the light rays from the LEDs of the speed up display area, the slow down display area and the brake display area are dispersed in the dispersal panel.

7. The moving condition display apparatus as claimed in claim 4, wherein the first series of LEDs are arranged into characters of “SPEED UP”, the second series of LEDs are arranged into characters of “SLOW DOWN” and the third series of LEDs are arranged into character of “BRAKE”.

8. The moving condition display apparatus as claimed in claim 4 further comprising a dispersal panel mounted to the casing and corresponding to a front side of the project panel, the dispersal panel parallel to the project panel such that the light rays from the LEDs of the speed up display area, the slow down display area and the brake display area are dispersed in the dispersal panel.

9. The moving condition display apparatus as claimed in claim 7 further comprising a dispersal panel mounted to the casing and corresponding to a front side of the project panel, the dispersal panel parallel to the project panel such that the light rays from the LEDs of the speed up display area, the slow down display area and the brake display area are dispersed in the dispersal panel.
